(19) United States
(12) Patent Application Publication
(10) Pub. No.: US 2007/0108231 A1
(43) Pub. Date: May 17, 2007

(54) Dispensing device for multiple constituent systems

(75) Inventors: Richard F. Gray, New York, NY (US); Christopher Mears, New York, NY (US); Ryan Crist, Jefferson, WI (US); Tony Kopp, West Allis, WI (US); Jason Rohr, Pewaukee, WI (US); Bruce Nemec, Madison, WI (US); Milton Dallas, East Troy, WI (US); Mort Westman, Oak Brook, IL (US)

Correspondence Address: VENABLE LLP, P.O. BOX 34385, WASHINGTON, DC, 20043-9998, US

(73) Assignee: Mixtek System, LLC, New York, NY (US)

(21) Appl. No.: 11/543,771

(22) Filed: Oct. 6, 2006

Related U.S. Application Data
(60) Provisional application No. 60/723,913, filed on Oct. 6, 2005.

(30) Foreign Application Priority Data
Oct. 6, 2006 (US) PCT/US06/39182

(51) Int. Cl. B67D 5/52; B67D 5/60

(52) U.S. Cl. 222/135; 222/145.6

(57) ABSTRACT

A dispensing device is provided which may include a nozzle adapted to receive and dispense a plurality of pressurized constituents. The nozzle may include an inlet portion; an outlet portion spaced from the inlet portion; and an actuation member receiving portion. The dispensing device may further include a head configured to receive the nozzle therein. The head may include a bottom part mountable atop a plurality of pressurized containers, and a top part adapted to be received on the bottom part of the head so as to substantially enclose the nozzle. The top part of the head may include a resilient actuation portion formed integrally thereon and adapted to be depressed by a user and an actuation member disposed on an internal surface of the resilient actuation portion of the head for contacting the nozzle actuation member receiving portion. In operation, when the nozzle and the head are mounted atop the plurality of pressurized containers and the resilient actuation portion of the head is depressed by the user, the nozzle may shift relative to the head so as to release the pressurized constituents from each of the plurality of pressurized containers into the nozzle for dispensing therefrom.

### CROSS REFERENCE To RELATED APPLICATIONS

This application is a non-provisional application based on U.S. Application No. 60/723,913, filed Oct. 6, 2005, the contents of which are hereby incorporated by reference in their entirety.

### BACKGROUND OF THE INVENTION

1. Field of the Invention

This invention relates to dispensers for multi-constituent products. More particularly, the invention relates to a dispensing device that may be attached to multiple containers for accepting constituents from the containers, and dispensing a mixed product or discrete side-by-side products.

2. Related Art

It has long been known to dispense a single-component fluid product under pressure from an aerosol or pump-type container or the like. Dispenser structures are also known which are formed on, or mountable to, a single pressurized dispensing container. Known single-container dispensing assemblies commonly include vertically-actuated valve assemblies which are triggered by vertical depression thereof, as well as tilt-actuated valve assemblies which are triggered by depression at angles between vertical and horizontal, inclusive. Such dispensing assemblies may be adequate for dispensing a single-component fluid product contained in a single pressurized container. Other dispensers may be used to convert a stream of a dispensed product into a form more useable for a given application.

Various types of dispensers are also known which are capable of dispensing a multi-constituent product by means of the ejection and mixing of at least two different, fluid constituents from separate containers. Dispensing devices that provide for the simultaneous release of materials from two containers in response to the pressing of a release valve or actuation of a pump generally include tubes, ducts, or similar structure for conveying each of the two materials from the respective containers to a chamber at which the materials are combined, the chamber having a single outlet port or nozzle at which the material is dispensed. For example, U.S. Pat. No. 4,773,562 discloses a dispenser of the latter type, which is used for dispensing a mixed two-constituent product. In U.S. Pat. No. 4,773,562, a dispensing head is provided-with a Y-shaped groove having lateral arms for separately conveying materials dispensed from two different containers to a median arm, where the two materials are mixed and conveyed as a combined product to a single projecting spout. Much like other prior art dispensing devices, however, this structure does not allow for easy removal and replacement of the dispensing portion after use.

In fluid application processes requiring the use of a multi-constituent product that must be mixed immediately before application to a given object, few known devices are capable of dispensing, mixing and applying such products in a satisfactory manner. For example, in the use of multi-component hair dye products, the user or stylist is generally required to carefully perform a number of manual operations to properly mix the individual components before applying the mixture to the hair. Epoxy adhesives, exothermic shaving creams, tooth whitening formulations, and some cleaning compounds, for example spot carpet cleaners, are further exemplary applications in which multi-constituent products must be mixed immediately before use.

Existing systems for dispensing multi-constituent products that are mixed or combined prior to use generally involve either (a) numerous components or (b) a large mixing system which may be difficult and/or expensive to manufacture. There is a continuing need for simple devices that can be produced economically in order to satisfy the various markets for mixed and co-dispensed products.

There exists an unmet need for an economical and ergonomic device and/or system that effectively and simultaneously receives constituents from multiple pressurized containers and dispenses the constituents as one of a mixed product, partially mixed product, or discrete side-by-side product streams. For example, where a chemical reaction is desired after dispensing, providing separate containers having a common nozzle for mixing and dispensing may be desirable. For example, to effectively apply an adhesive to a surface, it may be desirable to simultaneously dispense the component adhesive base along with the chemical activator capable of activating the adhesive properties of the adhesive base. The adhesive base and the chemical activator may, for example, be contained in first and second pressurized containers, and may then be released and mixed to form a homogeneous mixture which is dispensed onto a surface to be bonded. Other applications of chemical products that may benefit from mixing and dispensing through a common nozzle assembly include exothermic applications, where mixing two chemicals would yield a heated dispensed chemical composition. The unsolved challenges that have prohibited successful implementation of such multi-container applications, especially in the consumer products market, include, for example, controlled and consistent dispensing of a known quantity of each chemical, ability to dispense the chemicals in other than a 1:1 ratio, high manufacturing costs, and truly homogeneous mixing prior to expelling the mixed product through the nozzle outlet.

### BRIEF SUMMARY OF THE INVENTION

In one embodiment, the present invention is a dispensing device that includes a nozzle and a head. The nozzle is adapted to receive and dispense a plurality of pressurized constituents and includes an inlet portion, an outlet portion spaced from the inlet portion, and an actuation member receiving portion. The head is configured to receive the dispensing nozzle and includes a bottom part mountable atop a plurality of pressurized containers, and a top part adapted to be received on the bottom part of the head so as to substantially enclose the nozzle. The top part of the head has a resilient actuation portion formed integrally thereon and adapted to be depressed by a user, and an actuation member disposed on an internal surface of the resilient actuation portion of the head for contacting the nozzle actuation member receiving portion. When the nozzle and the head are mounted atop the plurality of pressurized containers and the resilient actuation portion of the head is depressed by the user, the nozzle shifts relative to the head so as to release the pressurized constituents from each of the plurality of pressurized containers into the nozzle for dispensing therefrom. The actuation member receiving portion of the nozzle can be a wedge-shaped recess and the actuation member disposed on an internal surface of the resilient actuation portion of the head an actuation tab adapted to be received by the wedge-shaped recess. Alternatively, the actuation member receiving portion of the nozzle can be a wedge-shaped tab and the actuation member disposed on an internal surface of the resilient actuation portion of the head an actuation recess adapted to receive the wedge-shaped tab.

The nozzle of the dispensing device can be adapted to shift at least partially laterally when the resilient actuation portion of the head is depressed by the user so as to activate at least one tilt-actuated valve on the plurality of pressurized containers. The nozzle can be adapted to mix the plurality of pressurized constituents and dispense the constituents as a mixed product.

The nozzle can also include a mixing chamber interposed between the inlet portion and the outlet portion to form a convoluted flow path between the inlet portion and the outlet portion for mixing the constituents to form the mixed product. The nozzle can have a combining portion in fluid communication with the inlet portion for receiving the constituents, and a mixing portion in fluid communication with the combining portion, where the mixing portion includes a plurality of mixing cells in fluid communication with one another along the direction of the flow path. At least a portion of the mixing portion of the nozzle can taper inwardly toward the outlet portion. The nozzle can be adapted to receive a plurality of pressurized constituents and dispense the constituents as discrete, side-by-side product streams.

The inlet portion of the nozzle can include a first inlet having a first channel, and a second inlet spaced from the first inlet and having a second channel. The nozzle can include a first flow chamber fluidly connecting the first channel to the outlet portion, at least a portion of the first flow chamber tapering inwardly towards the outlet portion, a second flow chamber fluidly connecting the second channel to the outlet portion, the second flow chamber being parallel to the first flow chamber and at least a portion of the second flow chamber tapering inwardly towards the outlet portion, and a wall disposed between the first flow chamber and the second flow chamber, the wall being configured, in use, to keep separate constituents from each of the plurality of pressurized containers. When the constituents from the plurality of pressurized containers are received in the first and second inlets, the constituents are conveyed through the first and second channels to the first and second flow chambers, respectively, to the outlet portion so as to be dispensed as discrete side-by-side product streams at the outlet portion.

An other embodiments, the invention is a nozzle for mixing a plurality of pressurized constituents and dispensing the constituents as a mixed product. The nozzle has an inlet portion for receiving the plurality of pressurized constituents and an outlet portion spaced from the inlet portion, the outlet portion for dispensing the mixed product. The nozzle also includes a mixing chamber interposed between the inlet portion and the outlet portion, the mixing chamber forming a convoluted flow path between the inlet portion and the outlet portion for mixing the constituents to form the mixed product. The mixing chamber can have a combining portion in fluid communication with the inlet portion for receiving the constituents, and a mixing portion in fluid communication with the combining portion, where the mixing portion includes a plurality of mixing cells in fluid communication with one another along the direction of the flow path, at least a portion of the mixing portion tapering inwardly toward the outlet portion. The inlet portion can include a plurality of inlets adapted to receive a valve stem on each of a plurality of pressurized containers. Each of the plurality of inlets can have interior walls having a conical configuration and can have a crab claw seal. The nozzle may be disposable. According to embodiments of the invention, the nozzle can have a channel from each of the plurality of inlets to the mixing chamber, the channels converging at a confluence in the combining portion. The confluence can be about equidistant from each inlet and each channel can have dimensions equal to the dimensions of the other channel such that, in use, the relative percentage by weight of each constituent in the mixed product is equal. Alternatively, each channel has dimensions that are different from the dimensions of the other channel such that, in use, the relative percentage by weight of each constituent in the mixed product differs from the relative percentage by weight of each other constituent in the mixed product.

Mixing portion of the nozzle can include a plurality of mixing portions including a first mixing portion in fluid communication with the combining portion, where the first mixing portion has a plurality of mixing cells in fluid communication with one another via consecutively unaligned openings along the direction of the flow path. The mixing portion can also have a second mixing portion in fluid communication with the first mixing portion, where the second mixing portion includes a plurality of mixing cells in fluid communication with one another via consecutively unaligned openings along the direction of the flow path. At least one of the first and second mixing portions of the mixing chamber can taper inwardly toward the outlet portion. The plurality of mixing cells of the first mixing portion can be separated by walls, each wall including at least one of the consecutively unaligned openings therein. The plurality of mixing cells of the second mixing portion are separated by walls, each wall including at least one of the consecutively unaligned openings therein. The first mixing portion can be the portion of the mixing chamber that tapers inwardly toward the outlet portion. Each of the plurality of mixing cells in the first mixing portion can become consecutively smaller than a previous mixing cell in the direction of the flow path. The second mixing portion can have a cylindrical configuration.

The outlet portion of the nozzle can include a cylindrical dispensing portion in fluid communication with the second mixing portion. The nozzle can include a top part and a bottom part, where the top and bottom parts are ultrasonically welded to one another. The top part and the bottom part can include walls integral therewith in the first mixing portion, the walls substantially separating the plurality of mixing cells and having at least one of the consecutively unaligned openings disposed therein. The walls of first mixing portion of the top part can substantially align with the walls of first mixing portion of the bottom part. The nozzle top part and the bottom part can include walls integral therewith in the second mixing portion, the walls substantially separating the plurality of mixing cells and having at least one of the consecutively unaligned openings disposed therein. The walls of the second mixing portion of the top part and the walls of the second mixing portion of the bottom part can alternatingly intermesh in the direction of the flow path between the inlet portion and the outlet portion.

In other embodiments, the invention is a dispensing system that includes a plurality of pressurized containers each having a valve stem; and a dispensing device as described above attached to the plurality of pressurized containers. The pressure in each of the plurality of pressurized containers can different from the pressure in another of the plurality of pressurized containers such that, in use, the constituents from each of the plurality of pressurized containers form a predetermined percentage by weight of a dispensed product. Alternatively, the pressure in each of the plurality of pressurized containers is equal to the pressure in another of the plurality of pressurized containers such that, in use, the constituents from each of the plurality of pressurized containers form a predetermined percentage by weight of a dispensed product. The valve on one of the plurality of pressurized containers can have dimensions that are different from the valve dimensions on another of the plurality of pressurized containers such that, in use, the constituents from each of the plurality of pressurized containers form a predetermined percentage by weight of a dispensed product. The valve of each of the plurality of pressurized containers can be a tilt-actuated valve. The dispensing system of the invention can include a collar adapted to secure the plurality of pressurized containers to one another.

In other embodiments, the invention is a mixing nozzle including an inlet portion adapted to accept constituents from each of a plurality of pressurized containers, an outlet portion adapted to dispense a mixed product and a mixing chamber forming a convoluted flow path between the inlet portion and the outlet portion, the mixing chamber being adapted, in use, to mix the constituents to form the mixed product. The mixing chamber can include a combining portion in fluid communication with the inlet portion, the combining portion, in use, being adapted to receive the constituents therein, a first mixing portion in fluid communication with the combining portion, the second mixing portion including a plurality of mixing cells in fluid communication with one another via consecutively unaligned openings along the direction of the flow path, and a second mixing portion in fluid communication with the first mixing portion, the second mixing portion including a plurality of mixing cells in fluid communication with one another via consecutively unaligned openings along the direction of the flow path. At least one mixing portion of the mixing chamber can taper inwardly toward the outlet portion.

The invention is also a multi-constituent side-by-side dispensing nozzle mountable atop a plurality of pressurized containers. The side-by-side dispensing nozzle has an inlet portion adapted to receive constituents from each of the plurality of pressurized containers. The inlet portion includes a first inlet having a first channel and a second inlet having a second channel. The nozzle also has an outlet portion adapted to dispense a product, a first flow chamber fluidly connecting the first channel to the outlet portion, at least a portion of the first flow chamber tapering inwardly towards the outlet portion, a second flow chamber fluidly connecting the second channel to the outlet portion, the second flow chamber being parallel to the first flow chamber and at least a portion of the second flow chamber tapering inwardly towards the outlet portion, and a wall disposed between the first flow chamber and the second flow chamber. The wall is configured such that, in use, it keeps separate the constituents from each of the plurality of pressurized containers. When constituents from the plurality of pressurized containers are received in the first and second inlets, the constituents are conveyed through the first and second channels to the first and second flow chambers, respectively, to the outlet portion so as to be dispensed as discrete side-by-side product streams at the outlet.

Further advantages, as well as the structure and function of exemplary embodiments, will become apparent from a consideration of the following description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an exploded front perspective view of an exemplary embodiment of a dispensing system according to the present invention;

FIG. 2 depicts a front view of an exemplary dispensing system according to the present invention;

FIG. 3 depicts a front perspective view of an exemplary embodiment of a mixing nozzle top part according to the present invention;

FIG. 3a depicts a bottom view of the exemplary mixing nozzle top part depicted in FIG. 3 according to the present invention;

FIG. 3b depicts a sectional view of the exemplary mixing nozzle top part depicted in FIG. 3a according to the present invention;

FIG. 4 depicts a front perspective view of an exemplary embodiment of a mixing nozzle bottom part according to the present invention;

FIG. 4a depicts a top view of the exemplary mixing nozzle bottom part depicted in FIG. 4 according to the present invention;

FIG. 4b depicts a sectional view of the exemplary mixing nozzle bottom part depicted in FIG. 4a according to the present invention;

FIG. 4c depicts a sectional view of the exemplary mixing nozzle bottom part depicted in FIG. 4a according to the present invention;

FIG. 4d depicts a detail view of the inlet portion of the exemplary mixing nozzle bottom part depicted in FIG. 4c according to the present invention;

FIG. 5 depicts a front perspective view of an exemplary embodiment of a mixing nozzle top part according to the present invention;

FIG. 5a depicts a bottom view the exemplary mixing nozzle top part depicted in FIG. 5a according to the present invention;

FIG. 5b depicts a sectional view of the exemplary mixing nozzle top part depicted in FIG. 5a according to the present invention;

FIG. 6 depicts a front perspective view of an exemplary embodiment of a mixing nozzle bottom part according to the present invention;

FIG. 6a depicts a top view of the exemplary mixing nozzle bottom part depicted in FIG. 6 according to the present invention;

FIG. 7 depicts a front perspective view of an exemplary embodiment of a top part of a dispensing device head according to the present invention;

FIG. 7a depicts a top view of the exemplary top part of the dispensing device head depicted in FIG. 7 according to the present invention;

FIG. 7b depicts a front view of the exemplary top part of the dispensing device head depicted in FIG. 7 according to the present invention;

FIG. 7c depicts a sectional view of the exemplary top part of the dispensing device head depicted in FIG. 7a according to the present invention;

FIG. 8 depicts a front perspective view of an exemplary embodiment of a bottom part of a dispensing device head according to the present invention;

FIG. 8a depicts a top view of the exemplary bottom part of the dispensing device head depicted in FIG. 8 according to the present invention;

FIG. 9 depicts a front perspective view of an exemplary embodiment of a base collar for pressurized containers according to the present invention;

FIG. 10 depicts an exploded front perspective view of an exemplary side-by-side dispensing nozzle assembly according to the present invention;

FIG. 10a depicts a bottom view of an exemplary top part of the side-by-side dispensing nozzle depicted in FIG. 10 according to the present invention;

FIG. 10b depicts a top view of an exemplary bottom part of the side-by-side dispensing nozzle depicted in FIG. 10 according to the present invention;

FIG. 11 depicts an exemplary embodiment of a dispensing system operating according to the present invention;

FIG. 12 depicts a mixing nozzle according to an exemplary embodiment of the present invention;

FIG. 12 depicts a detail of the inlet columns of the mixing nozzle of FIG. 12 according to an exemplary embodiment of the present invention;

FIG. 13 depicts a mixing nozzle molding configuration according to an exemplary embodiment of the present invention;

FIG. 14A depicts a top view of a unitarily molded head and mixing nozzle according to an exemplary embodiment of the present invention;

FIG. 14B depicts a bottom view of a unitarily molded head and mixing nozzle according to an exemplary embodiment of the present invention;

FIG. 14C depicts a side view of the unitarily molded head and mixing nozzle of FIG. 14A in an unactuated state according to an exemplary embodiment of the present invention;

FIG. 14D depicts a side view of the unitarily molded head and mixing nozzle of FIG. 14A in an actuated state according to an exemplary embodiment of the present invention;

FIG. 15 depicts a one piece head according to an exemplary embodiment of the present invention;

FIG. 16 depicts a top view of a device that includes a shipping post; according to an exemplary embodiment of the present invention;

FIG. 17 depicts an alternative embodiment of a dispensing device according to an exemplary embodiment of the present invention;

FIG. 17A depicts an exploded view of the dispensing device of FIG. 17 according to an exemplary embodiment of the present invention; and

FIG. 17B depicts actuation of the dispensing device of FIG. 17 according to an exemplary embodiment of the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

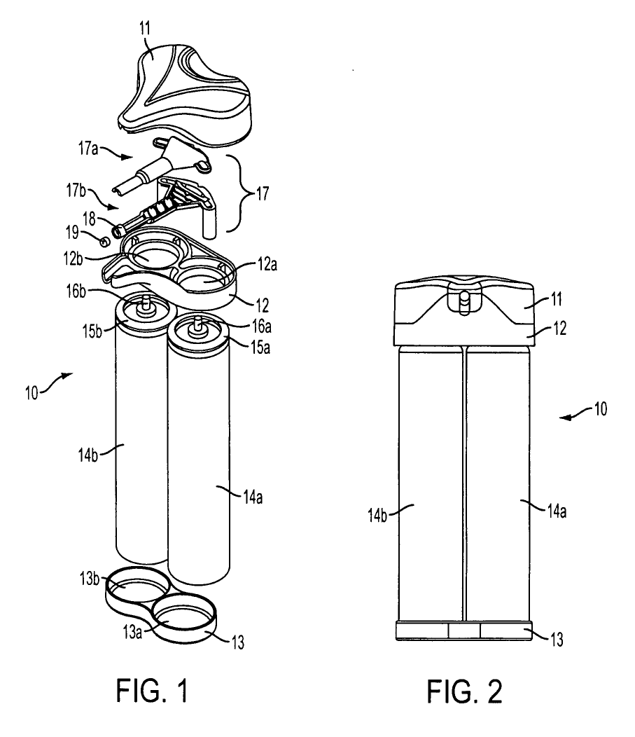

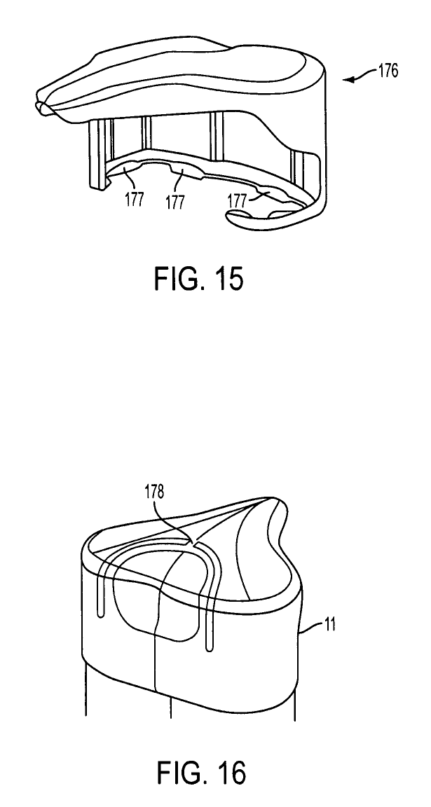

FIG. 1 depicts an exploded front perspective view of an exemplary embodiment of a dispensing system 10 according to the present invention. The dispensing system 10 may include a dispensing device head having a top part 11 and a bottom part 12 which may be mounted atop a plurality of pressurized containers 14a, 14b. Alternatively, the dispensing device head may be formed as one piece (See FIG. 15). Bottom part 12 of the dispensing device head may, for example, include appropriately sized openings 12a, 12b for receiving a top portion 15a, 15b of each of the plurality of pressurized containers 14a, 14b, respectively. Additionally, a base collar 13 having receiving openings 13a, 13b may also be employed to secure the base ends of the pressurized containers 14a, 14b together. Plastic shrink-wrap, for example, may also be used to secure the pressurized containers together as a unit. Alternatively, the pressurized containers 14a, 14b may be embodied, for example, as a single container having a plurality of separated compartments therein for each pressurized constituent. Each of the plurality of pressurized containers 14a, 14b may also include a valve having a valve stem 16a, 16b, respectively, for release of pressurized constituents therein. The valves 16a, 16b may, for example, be vertically-actuated valves or, alternatively, tilt-actuated valves.

FIG. 1 further shows the dispensing system 10 including a nozzle such as, for example, mixing nozzle 17, which may be received within the dispensing device head and adapted to receive the valve stems 16a, 16b of the plurality of pressurized containers 14a, 14b. Mixing nozzle 17 may include a top part 17a and a bottom part 17b. Top part 17a and bottom part 17b of the mixing nozzle 17 may be attached to one another to form mixing nozzle 17 by any known method of forming a sealed connection including, for example, fasteners, friction fitting, adhesive, a tongue and groove joint, and/or ultrasonic welding or the like. Bottom part 17b of the mixing nozzle 17 may also include a front nozzle portion 18 which may receive a valve insert 19, such as a mechanical breakup valve insert, to atomize a dispensed product such that it is dispensed in the form of a spray, including, for example, a fine spray. A nozzle of the dispensing system 10 may be adapted to vary spray properties by modifying the dimensions of the valve insert 19, removing the valve insert 19, and/or adjusting the pressure of the propellant in the pressurized containers 14a, 14b. Top part 17a and bottom part 17b of the mixing nozzle 17 are discussed further below.

FIG. 2 depicts a front view of an exemplary dispensing system 10 according to the present invention. The plurality of pressurized containers 14a, 14b may be secured together by the top and bottom parts 11, 12 of the dispensing device head and the base collar 13 to form a hand-held, ergonomic dispensing system 10. Similar exemplary dispensing systems are shown and described in U.S. Pat. No. 6,877,924, U.S. Pat. No. 6,168,335, U.S. Design Pat. D480,960, International Application No. PCT/US2003/022282 published as WO 2004/007346A2, and International Application No. PCT/US2004/043812 published as WO 2005/065343A2, each of which is incorporated herein by reference in its entirety.

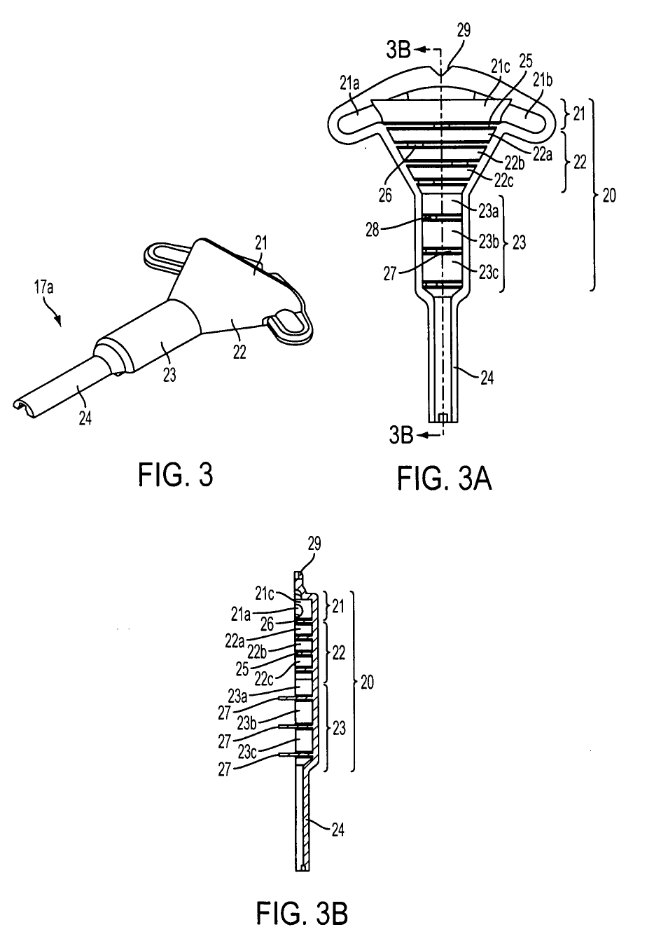

FIGS. 3, 3a and 3b depict several views of an exemplary mixing nozzle top part 17a. FIG. 3, for example, depicts a front perspective view of an exemplary embodiment of a mixing nozzle top part 17a according to the present invention. The exemplary mixing nozzle top part 17a includes, in series, a top combining portion 21, a first top mixing portion 22, a second top mixing portion 23, and a nozzle top outlet portion 24, each of which is shown in further detail in FIG. 3a. As further discussed herein, the mixing nozzle top part 17a may be attached to the mixing nozzle bottom part 17b to form mixing nozzle 17.

FIG. 3a depicts a bottom view of the exemplary mixing nozzle top part 17a depicted in FIG. 3 according to the present invention. The exemplary mixing nozzle top part 17a includes mixing chamber top portion 20. The mixing chamber top portion 20 includes, in series, top combining portion 21, first top mixing portion 22, second top mixing portion 23, and nozzle top outlet portion 24. Top combining portion 21 includes, for example, top inlet feed portions 21a, 21b in fluid communication with a central confluence top portion 21c. First top mixing portion 22 includes a plurality of mixing cells 22a, 22b, 22c separated from the central confluence top portion 21c of the top combining portion 21, and from one another, by a plurality of walls 25 therebetween. The first mixing cell 22a of the first top mixing portion 22 is in fluid communication with the central confluence top portion 21c of the top combining portion 21 via a flow opening 26. Likewise, each of the mixing cells 22a, 22b, 22c is in fluid communication with one another via flow openings 26, which may be consecutively unaligned along a general direction of the flow path so as to induce a turbulent flow to mix constituents received therein. The first top mixing portion 22 also includes a tapered configuration, the plurality of mixing cells 22a, 22b, 22c having consecutively decreasing volumes, respectively, in a direction towards the nozzle top outlet portion 24.

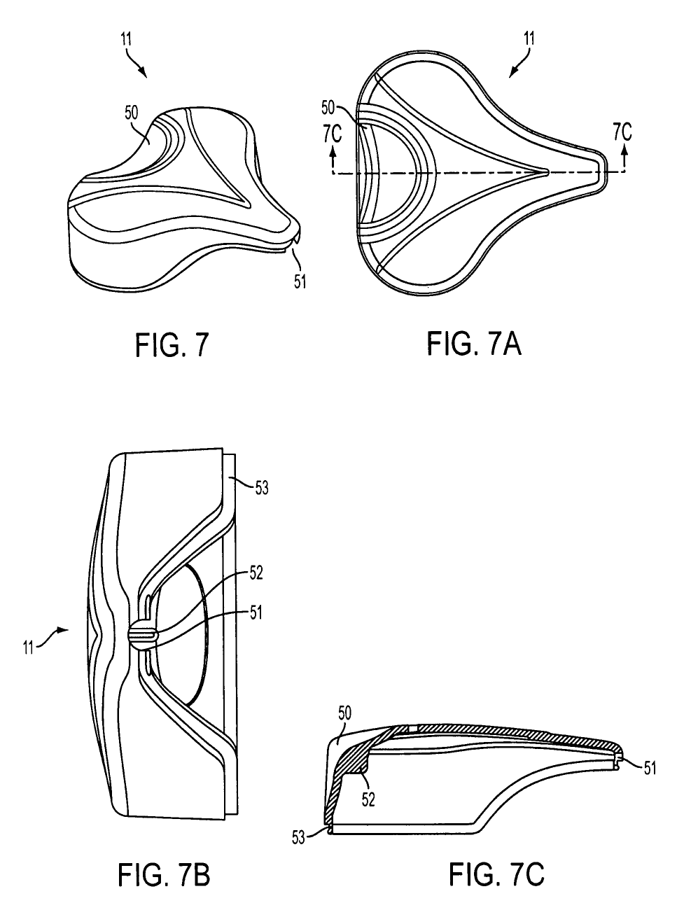

Second top mixing portion 23 includes a plurality of mixing cells 23a, 23b, 23c separated from the first top mixing portion 22, and from one another, by a plurality of walls 27 therebetween. The first mixing cell 23a of the second top mixing portion 23 is in fluid communication with the last mixing cell 22c of the first top mixing portion 21 via a flow opening 26. Likewise, each of the mixing cells 23a, 23b, 23c is in fluid communication with one another via flow openings 28, which may be aligned along a general direction of the flow path toward the top outlet portion 24. The second top mixing portion 23 may have a substantially cylindrical configuration extending in a direction towards the nozzle top outlet portion 24. A top actuation member receiving portion 29 is also included, for example, at an end of the mixing nozzle top part 17a to receive an actuation member 52, discussed further below with regard to FIGS. 7b & 7c. FIG. 3b depicts a sectional view of the exemplary mixing nozzle top part 17a depicted in FIG. 3a according to the present invention.

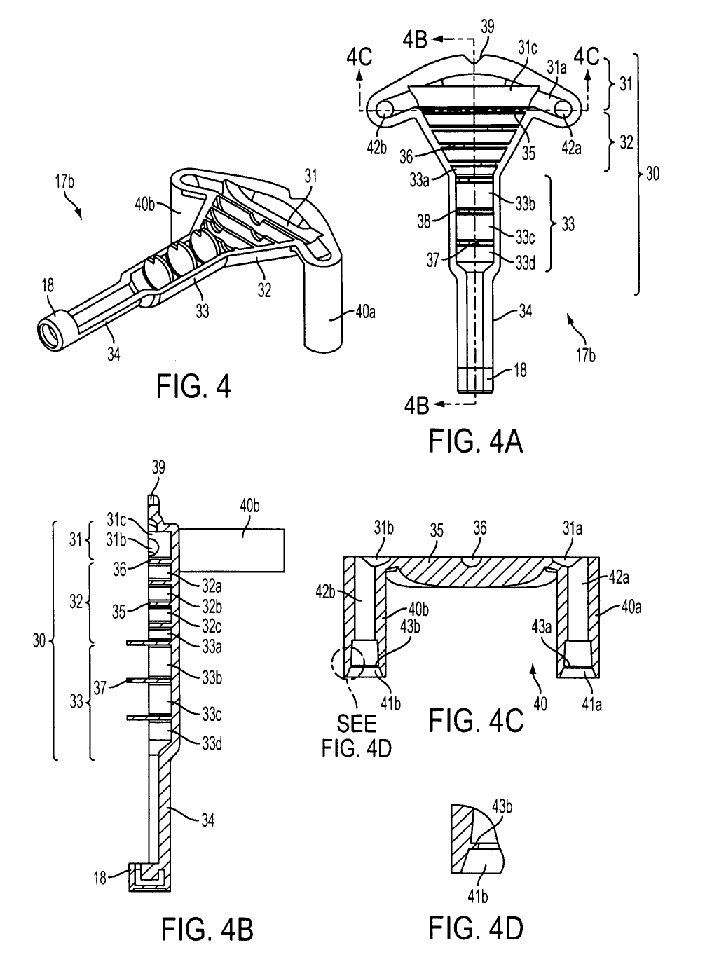

FIGS. 4, 4a and 4b depict several views of an exemplary mixing nozzle bottom part 17b. FIG. 4, for example, depicts a front perspective view of an exemplary embodiment of a mixing nozzle bottom part 17b according to the present invention. The exemplary mixing nozzle bottom part 17b includes, in series, a bottom combining portion 31, a first bottom mixing portion 32, a second bottom mixing portion 33, and a nozzle bottom outlet portion 34 with optional front nozzle portion 18, each of which is shown in further detail in FIG. 4a. The mixing nozzle bottom part 17b is adapted to be mated with and attached to the mixing nozzle top part 17a described above with reference to FIGS. 3, 3a and 3b to form mixing nozzle 17.

FIG. 4a depicts a top view of the exemplary mixing nozzle bottom part 17b depicted in FIG. 4 according to the present invention. The exemplary mixing nozzle bottom part 17b includes the mixing chamber bottom portion 30. The bottom portion of mixing chamber 20 includes, in series, bottom combining portion 31, first bottom mixing portion 32, second bottom mixing portion 33, and nozzle bottom outlet portion 34. Bottom combining portion 31 includes, for example, bottom inlet feed portions 31a, 31b in fluid communication with a central confluence bottom portion 31c. First bottom mixing portion 32 includes a plurality of mixing cells 32a, 32b, 32c separated from the central confluence bottom portion 31c of the first bottom mixing portion 31, and from one another, by a plurality of walls 35 therebetween. The first mixing cell 32a of the first bottom mixing portion 22 is in fluid communication with the central confluence bottom portion 31c of the bottom combining portion 31 via a flow opening 36. Each of the mixing cells 32a, 32b, 32c is in fluid communication with one another via flow openings 36, which may be consecutively unaligned along a general direction of the flow path so as to induce a turbulent flow to mix constituents received therein. The first bottom mixing portion 32 also has a tapered configuration matching the first top mixing portion 22, the plurality of mixing cells 32a, 32b, 32c having consecutively decreasing volumes, respectively, in a direction towards the nozzle bottom outlet portion 34.

Second bottom mixing portion 33 includes a plurality of mixing cells 33a, 33b, 33c, 33d separated from the first bottom mixing portion 32, and from one another, by a plurality of walls 37 therebetween. The first mixing cell 33a of the second bottom mixing portion 33 is in fluid communication with the last mixing cell 32c of the first bottom mixing portion 31 via a flow opening 36. Each of the mixing cells 33a, 33b, 33c, 33d is in fluid communication with one another via flow openings 38, which may be aligned along a general direction of the flow path toward the bottom outlet portion 34. The second bottom mixing portion 33 may have a substantially cylindrical configuration extending in a direction towards the nozzle bottom outlet portion 34. Bottom part 17b of the mixing nozzle 17 may also include a front nozzle portion 18 which may receive a valve insert 19 such as a mechanical breakup valve insert to atomize a dispensed product such that it is dispensed in the form of a fine spray. A bottom actuation member receiving portion 39 is also included at an end of the mixing nozzle bottom part 17b to receive an activation member 52, discussed further below with regard to FIGS. 7b & 7c. FIG. 4b depicts a sectional view of the exemplary mixing nozzle bottom part 17b depicted in FIG. 4a according to the present invention.

FIG. 4c depicts a sectional view of the exemplary mixing nozzle bottom part 17b depicted in FIG. 4a according to the present invention. The mixing nozzle bottom part 17b further includes inlet portion 40 including inlet columns 40a, 40b. Inlet columns 40a, 40b include inlets 41a, 41b, respectively, which may have conical configurations so as to more readily accept protruding valve stems 16a, 16b of pressurized containers 14a, 14b. Inlet columns 40a, 40b further include inlet channels 42a, 42b extending therethough and fluidly connecting inlets 41a, 41b to bottom inlet feed portions 31a, 31b. FIG. 4d depicts a detail view of the inlet portion of the exemplary mixing nozzle bottom part 17b depicted in FIG. 4c. As shown in FIG. 4d, inlets 41a, 41b may also include crab claw seals 43a, 43b, respectively, which can serve to grab and seal inserted valve stems 16a, 16b and thus avoid the need for o-rings or other seals and additional parts.

Upon assembly of mixing nozzle top part 17a and mixing nozzle bottom part 17b to form mixing nozzle 17, top and bottom combining portions 21 and 31 align to form the mixing nozzle combining portion; first top and bottom mixing portions 22 and 32 align to form the mixing nozzle first mixing portion; second top and bottom mixing portions 23 and 33 align to form the mixing nozzle second mixing portion; and nozzle top and bottom outlet portions 24 and 34 align to form the mixing nozzle outlet portion. In the first mixing portion of the mixing nozzle 17, top walls 25 align with bottom walls 35 to substantially separate the combined mixing cells formed by top mixing cells 22a, 22b, 22c and bottom mixing cells 32a, 32b, 32c, respectively. Likewise, top flow openings 26 align with bottom flow openings 36 to create continuous flow openings between the combined mixing cells at staggered positions along the general direction of the flow path.

Conversely, in the second mixing portion of the mixing nozzle 17, top walls 27 may be, upon assembly, intermeshed between bottom walls 37 such that top walls 27 bisect each of the bottom mixing cells 33b, 33c, 33d and bottom walls 37 bisect each of the top mixing cells 23a, 23b, 23c. Furthermore, upon assembly of the mixing nozzle top and bottom parts 17a, 17b, the top flow openings 28 may be unaligned with the bottom flow openings 38 so as to induce a turbulent flow to mix constituents received therein. The mixing portion may also have a portion thereof with a tapered configuration such that the plurality of combined mixing cells have consecutively decreasing volumes, respectively, in a direction towards the nozzle outlet portion.

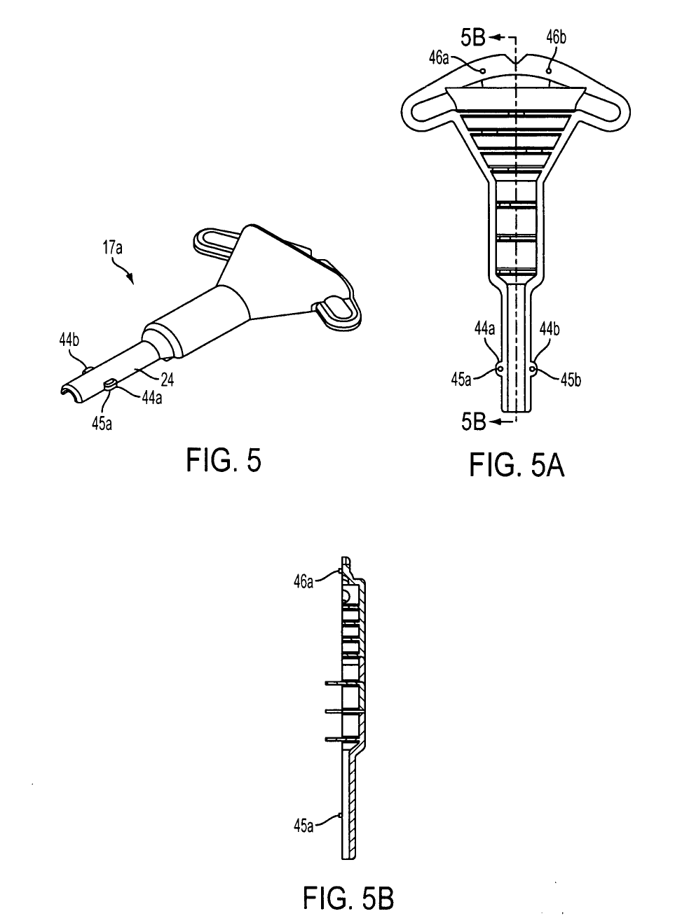

FIGS. 5, 5a and 5b depict several views of an exemplary mixing nozzle top part 17a. The mixing nozzle top part 17a shown in FIGS. 5, 5a and 5b is substantially the same as that depicted in FIGS. 3, 3a and 3b except for the extended configuration of the nozzle top outlet portion 24 and several additional top attachment features 44a, 44b, 45a, 45b, 46a and 46b. In this embodiment, the nozzle top outlet portion 24 may have a cylindrical configuration and may be provided with top attachment features including side tabs 44a, 44b and side tab posts 45a, 45b. A rear portion of the mixing nozzle top part 17a may further be provided with posts 46a, 46b. FIG. 5a depicts a bottom view the exemplary mixing nozzle top part depicted in FIG. 5a according to the present invention. FIG. 5b depicts a sectional view of the exemplary mixing nozzle top part 17a depicted in FIG. 5a according to the present invention.

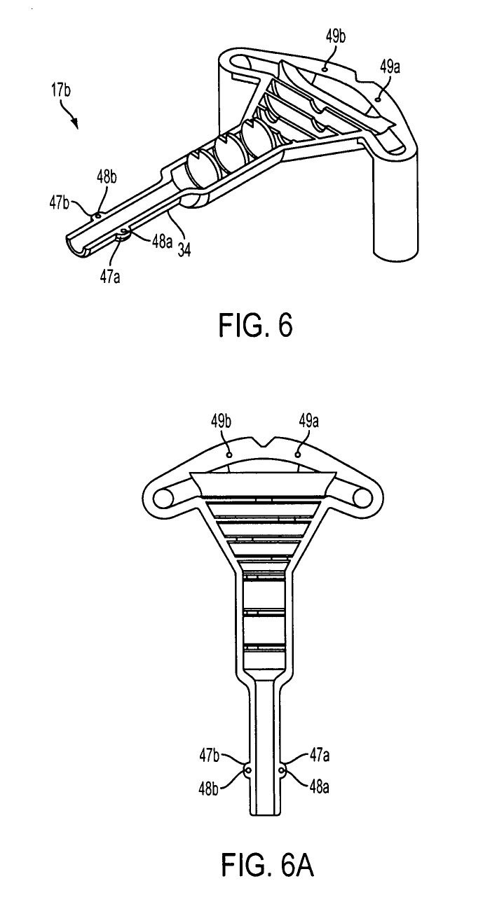

FIGS. 6 and 6a depict several views of an exemplary mixing nozzle bottom part 17b. FIG. 6 depicts a front perspective view of an alternative exemplary embodiment of a mixing nozzle bottom part according to the present invention. The mixing nozzle bottom part 17b shown in FIGS. 6 and 6a is substantially the same as that depicted in FIGS. 4, 4a and 4b except for the configuration of the nozzle bottom outlet portion 24 without nozzle front portion 18. The mixing nozzle bottom part 17b in this embodiment may also include several additional bottom attachment features 47a, 47b, 48a, 48b, 49a and 49b. In this embodiment, the nozzle bottom outlet portion 24 may have a cylindrical configuration and may be provided with top attachment features including side tabs 47a, 47b and side tab holes 48a, 48b capable of receiving side tab posts 45a, 45b on mixing nozzle top part 17a. A rear portion of the mixing nozzle bottom part 17b may further be provided with holes 49a, 49b capable of receiving posts 46a, 46b on mixing nozzle top part 17a. FIG. 6a depicts a top view of the exemplary mixing nozzle bottom part 17b depicted in FIG. 6 according to the present invention. Upon assembly of the top and bottom mixing nozzle parts 17a, 17b, the mixing nozzle 17 may also be configured to receive a valve insert 19, such as a mechanical breakup valve insert, to atomize a dispensed product such that it is dispensed in the form of a fine spray.

FIGS. 7, 7a, 7b and 7c depict several views of an exemplary dispensing device head top part 11. FIG. 7, for example, depicts a front perspective view of an exemplary embodiment of a top part 11 of a dispensing device head according to the present invention. The top part 11 of the dispensing device head includes an integrally formed resilient actuation portion 50 which may be, for example, a flexible button which is adapted to be depressed inwardly and/or at least partially laterally by a user. The dispensing device head top part 11 also includes a front recess 51 through which a nozzle outlet portion of the mixing nozzle 17, for example, may protrude when received therein. Resilient actuation portion 50 includes an actuation member 52 on the inner side thereof for contacting the actuation member receiving portion 29,39 on the mixing nozzle 17, for example. Actuation member 52 may, for example, be a tab or protrusion configured to be received by the actuation member receiving portion 29,39 which may be in the form of a wedge-shaped recess, for example. Alternatively, actuation member 52 may, for example, be a wedge-shaped recess configured to be received by the actuation member receiving portion 29,39 which may be in the form of a tab or protrusion, for example.

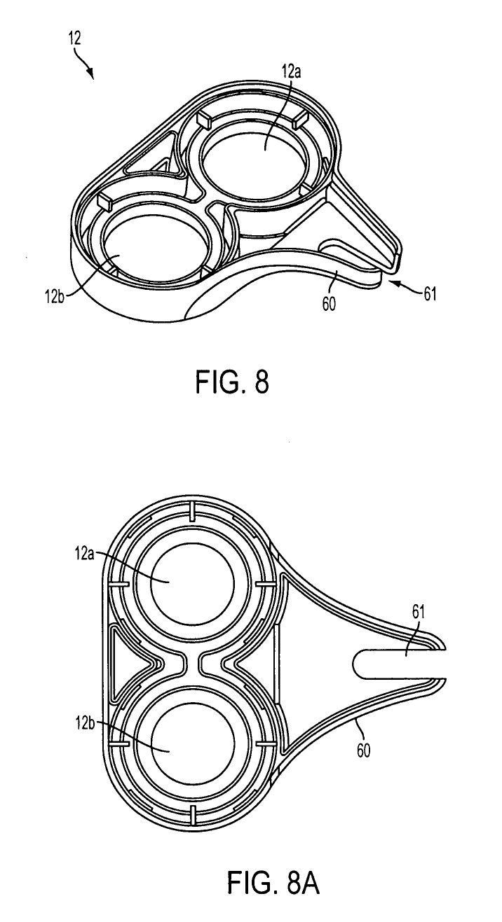

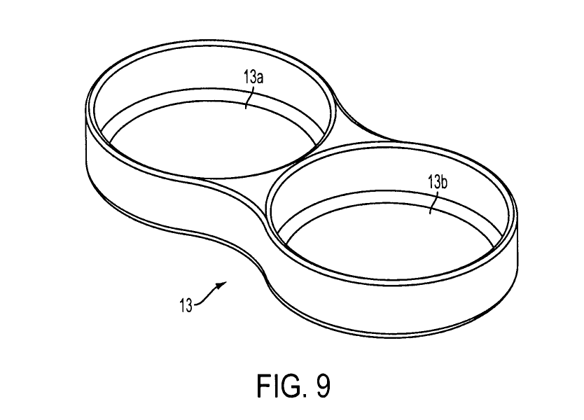

When the actuation member 52 is depressed by a user, it flexes inwardly and effects at least a partial lateral movement of the mixing nozzle 17 so as to release pressurized constituents from the plurality of pressurized containers 14a, 14b, into, through, and out of the mixing nozzle 17. The dispensing device head top part 11 may also have a recessed connection skirt 53 for connection to the bottom part 12, which bottom part 12 is discussed further below with reference to FIG. 8.

FIGS. 8 and 8a depict several views of an exemplary dispensing device head bottom part 12. FIG. 8, for example, depicts a front perspective view of an exemplary embodiment of a bottom part 12 of a dispensing device head according to the present invention, including openings 12a, 12b adapted to receive top portions 15a, 15b of the plurality of pressurized containers 14a, 14b. The dispensing device bottom part 12 further includes a curvilinear spout portion 60 having an outlet slot 61 through which the nozzle outlet portion of the mixing nozzle 17 may protrude when received therein. FIG. 8a depicts a top view of the exemplary bottom part 12 of the dispensing device head depicted in FIG. 8 according to the present invention.

FIG. 9 depicts a front perspective view of an exemplary embodiment of a base collar 13 for pressurized containers 14a, 14b according to the present invention. The base collar 13 includes openings 13a, 13b for receiving the base portions of the pressurized containers 14a, 14b so as to secure them together in a substantially parallel configuration. Plastic shrink-wrap, for example, may also be used to secure the pressurized containers together as a unit.

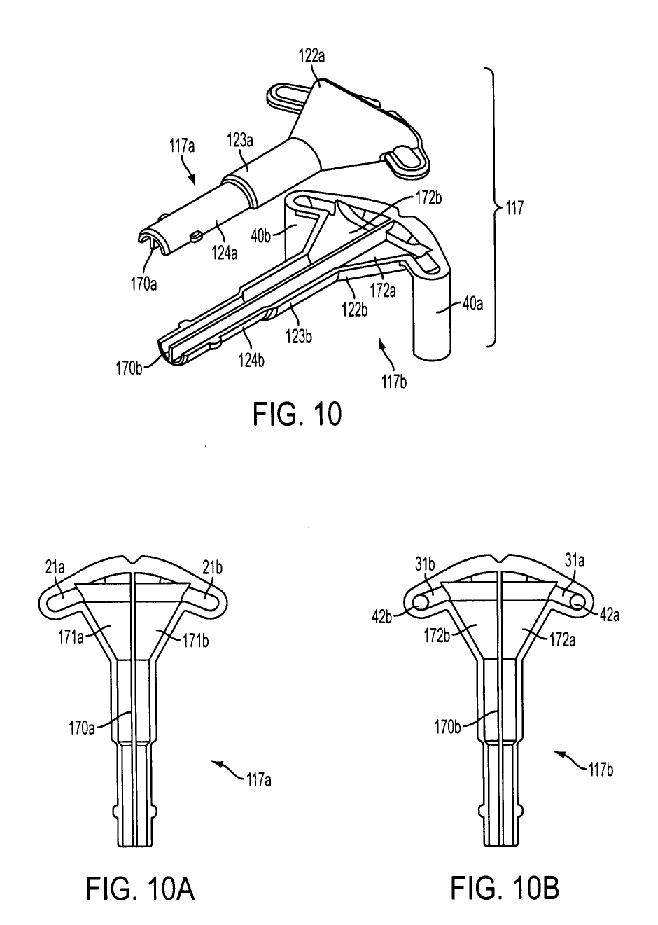

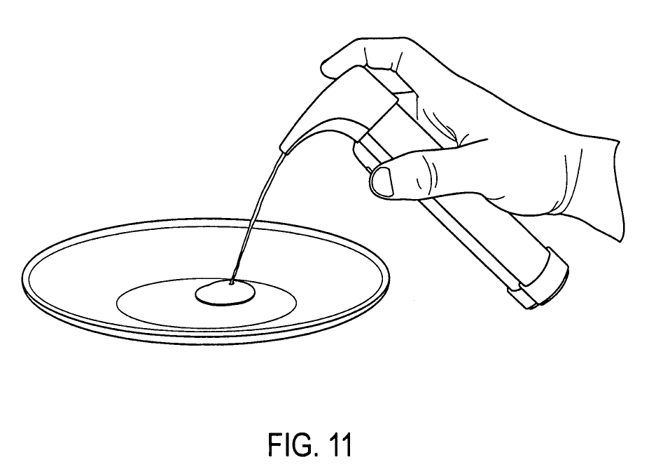

FIG. 10 depicts an exploded front perspective view of an alternative exemplary nozzle in the form of a side-by-side dispensing nozzle assembly 117. The side-by-side dispensing nozzle assembly 117 includes top and bottom portions 117a, 117b, respectively. FIG. 10a depicts a bottom view of an exemplary top part 117a of the side-by-side dispensing nozzle 117 depicted in FIG. 10. FIG. 10b depicts a top view of an exemplary bottom part 117b of the side-by-side dispensing nozzle 117 depicted in FIG. 10. Side-by-side dispensing nozzle top portion 117a includes several portions that are substantially the same as the top portion 17a of mixing nozzle 17 such as the inlet feed portions 21a, 21b. The side-by-side dispensing nozzle top portion 117a further includes, however, a first top flow chamber 171a in fluid communication with inlet top feed portion 21a as well as a second top flow chamber 171b in fluid communication with inlet top feed portion 21b. The first top flow chamber 171a and second flow chamber 171b may extend substantially the entire length of the side-by-side dispensing nozzle top portion 117a and are separated by a dividing wall 170a which also extends substantially the entire length of the side-by-side dispensing nozzle top portion 117a.

Side-by-side dispensing nozzle bottom portion 117b includes several portions that may be substantially the same as the bottom portion 17b of mixing nozzle 17 such as the inlet portion 40 including inlet columns 40a, 40b, inlets 41a, 41b, inlet channels 42a, 42b, and inlet feed portions 31a, 31b. The side-by-side dispensing nozzle bottom portion 117b further includes, however, a first bottom flow chamber 172a in fluid communication with inlet channel 42a and bottom inlet feed portion 31a as well as a second bottom flow chamber 172b in fluid communication with inlet channel 42b and bottom inlet feed portion 31b. The first bottom flow chamber 172a and second bottom flow chamber 172 may extend substantially the entire length of the side-by-side dispensing nozzle bottom portion 117b and are separated by a dividing wall 170b which also extends substantially the entire length of the side-by-side dispensing nozzle bottom portion 117b.

Upon assembly of side-by-side dispensing nozzle top and bottom portions 117a, 117b, the first top flow chamber 171a aligns with the first bottom flow chamber 172a to form a first flow chamber 171 and the second top flow chamber 171b aligns with the second bottom flow chamber 172b to form a second flow chamber 172. Top dividing wall 170a also aligns with bottom dividing wall 170b so as to separate the first and second flow chambers 171, 172 and prevent mixing of constituents received in each of flow chambers 171, 172 until the constituents exit the nozzle 117.

The exemplary side-by-side dispensing nozzle 117 may have an exterior that is structurally the same as, or substantially similar to, that of the mixing nozzle 17 discussed above with reference to, for example, FIGS. 1, 3 and 4. This allows the side-by-side dispensing nozzle 117 to be received within and used with the dispensing device head top and bottom parts 11, 12 as substantially described above.

FIG. 11 depicts an exemplary embodiment of the dispensing system 10 in operation. In operation, the dispensing system 10 may be held in a user's hand H such that the user's finger F can depress the resilient actuation portion 50. When the resilient actuation portion 50 is depressed inwardly, a nozzle such as, for example, mixing nozzle 17 or side-by-side dispensing nozzle 117, is shifted at least partially laterally within the dispensing device head so as to release the pressurized constituents through the tilt-actuated valves 16a, 16b of each of the pressurized containers 14a, 14b. In turn, the constituents are received in the nozzle and dispensed therefrom as a product P in the form of, for example, an aerosol spray, a fluid stream, a homogeneous mixture or discrete side-by-side product streams. The dispensing system 10 may also be configured to dispense a multi-constituent product in other than a 1:1 ratio. Such a variable ratio multi-constituent product may be accomplished in several ways according to the present invention. For example, one of the channels 42a, 42b on the mixing nozzle 17 or side-by-side dispensing nozzle 117 of the dispensing system 10 may have dimensions different from the dimensions of the other channel such that, in use, the relative percentage by weight of each constituent in the mixed product or discrete side-by-side product streams is other than in a 1:1 ratio. Alternatively, one of the valves 16a, 16b on pressurized containers 14a, 14b may, for example, have internal dimensions different from the internal dimensions of the other valve 16a, 16b such that, in use, the relative percentage by weight of each constituent in the mixed product or discrete side-by-side product streams is other than in a 1:1 ratio. In another exemplary embodiment, the pressure in each of the plurality of pressurized containers 14a, 14b may be, for example, different from the pressure in the other pressurized container 14a, 14b such that, in use, the relative percentage by weight of each constituent in the mixed product or discrete side-by-side product streams is other than in a 1:1 ratio.

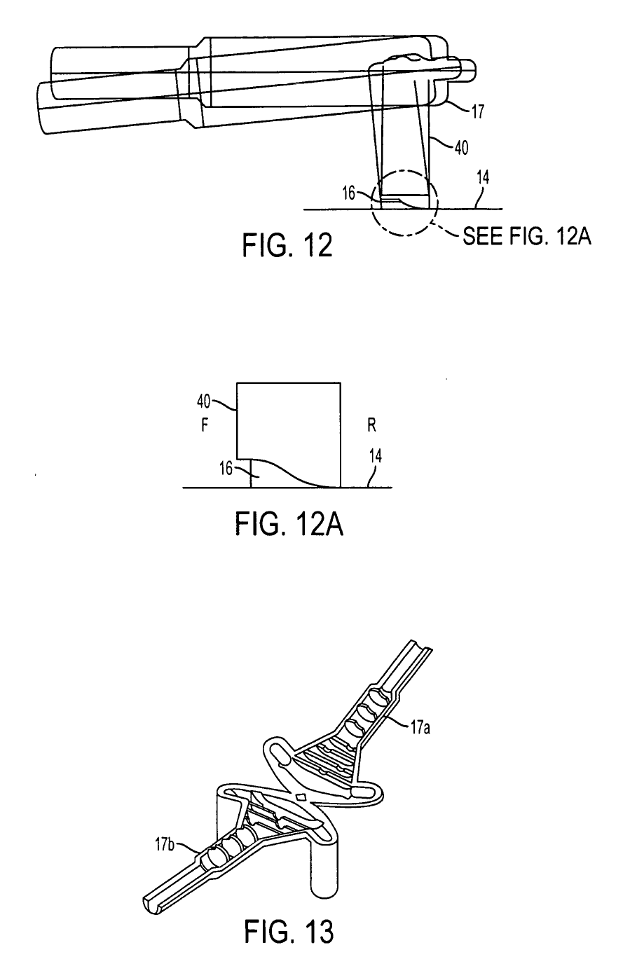

FIGS. 12-17 illustrate additional embodiments or features that may be used with the present invention. In general, these embodiments and features represent optional aspects of the design. These features are in the form of design choices, which allow for variability with respect to aesthetics or design variability, manufacturing options that may be employed to reduce costs or facilitate ease of molding, and features that may be advantageous for particular applications.

For example, FIG. 12 illustrates an embodiment of the mixing nozzle having inlet columns with modified end portions. For clarity, the head portion is not illustrated in FIG. 12, so that only the contact between the mixing nozzle and pressurized containers is illustrated. During manufacture, the dispensing device must be assembled onto pressurized containers 14 (individually designated 14a and 14b in FIG. 1) containing the aerosolized component products it is to dispense. This requires the insertion of the valve stems 16 (individually designated 16a and 16b in FIG. 1) into the inlet columns 40 (individually designated 40a and 40b in FIG. 1) of the mixing nozzle 17. Such insertion is achieved by placing the inlet columns 40 of the nozzle onto the valve stems 16 and exerting a force along, or parallel to, the axis of the valve stems 16 (hereafter referred to as “vertical force”). Tilt-action aerosol valves that can be used with the invention are designed to be actuated primarily through the exertion of force diagonal to the valve stem; however, such valves can also be actuated by vertical force. The vertical force required to install the inlet columns 40 over the valve stems 16 could result in the inadvertent dispensing of the aerosol components to within the nozzle. This is to be avoided since the dispensed material could harden in place during the period of time prior to the product reaching the end user, resulting in the clogging or malfunction of the nozzle. This is particularly true in situations where the product to be dispensed is an adhesive, which could cure in the mixing nozzle, or a product having volatile components (including water) which could evaporate during manufacture or storage to leave a solid residue.

In order to avoid such inadvertent actuation, as shown in FIGS. 12 and 12a, the bottom of each inlet column 40 can be sloped upward from rear R (extremity closest to the nozzle actuation member) to front F (extremity closest to the outlet orifice). This slope can be curvilinear, as illustrated, or linear. This slope inhibits the valve stem 16 from being depressed by vertical force to the extent that would dispense product. Significant downward vertical force would result in the rear, or longest extremity of the inlet column, contacting the top of the pressurized container 14 (which can be referred to as the valve cup) before actuating the valve. At the same time, the upward slope towards the front of the mixing nozzle 17 allows the valve stem 16 to rock forward without contacting the valve cup and hence actuate freely in response to a diagonal force applied to the nozzle from the rear, the only direction from which the dispensing system is designed to actuate. In addition, the sloped design inhibits the valve stem 16 from being actuated by a diagonal force emanating from any direction other than the rear.

This feature can be used in conjunction with the interior design of the inlet channels illustrated in FIG. 4d, including the sealing and valve stem retention features (e.g., crab claw seals 43a, 43b) within, to require less vertical force for the insertion of valve stems 16 into the inlet columns 40 than that required for actuation of the aerosol valves. By way of example, the vertical force required to achieve initial actuation (depression by 0.030″) and full actuation (depression by 0.085″) of the Precision tilt-action aerosol valve (such as those supplied by Precision Valve Corporation 700 Nepperhan Avenue, Yonkers, N.Y. 10703) that can be used with the present dispensing system (supplied by Precision Valve Corporation 700 Nepperhan Avenue, Yonkers, N.Y. 10703) are reported in TABLE 1. The use of the illustrated curvilinear inlet columns can help ensure that forces adequate to affect actuation are not achieved.

TABLE 1

| | COMPRESSION | FORCE REQUIRED TO ACTUATE VALVE (POUNDS) | | | | | |
|---|---|---|---|---|---|---|---|
| VALVE | DISTANCE | REPETITION | | | | | |
| CODE | (INCHES) | 1 | 2 | 3 | 4 | 5 | AVERAGE |
| INITIAL ACTUATION: | | | | | | | |
| 1 | 0.030″ | 5.0 | 4.5 | 5.0 | 4.7 | 3.8 | 4.6 |
| 2 | 0.030″ | 3.7 | 4.0 | 3.5 | 4.2 | 3.7 | 3.8 |
| | | | AVERAGE FORCE TO ACTUATE | | | | 4.2 |
| FULL ACTUATION: | | | | | | | |
| 1 | 0.085″ | 11.0 | 12.0 | 12.2 | 11.7 | 11.3 | 11.6 |
| 2 | 0.085″ | 9.5 | 12.0 | 10.5 | 11.7 | 9.8 | 10.7 |

| | |
|---|---|
| AVERAGE FORCE TO ACTUATE | 11.2 |

FIG. 13 illustrates a manufacturing method that may be used in molding the mixing nozzle 17. The mixing nozzle 17 can be molded in two pieces, as shown in FIGS. 1-6 and 10 or molded as a single hinged piece in a clam-shell like configuration, as shown in FIG. 13. In either manufacturing option, the two halves of the mixing nozzle 17a, 17b, may be joined by, for example, ultrasonically welding. Use of the clam shell configuration of FIG. 13 can result in cost reduction during molding, and ultrasonic welding.

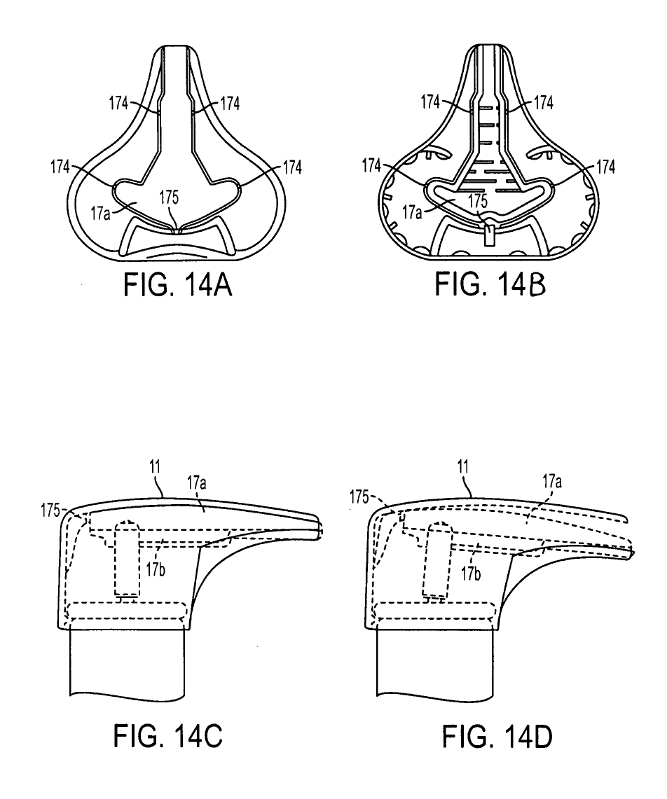

FIGS. 14A-14D illustrate another embodiment that can facilitate manufacture of the device. This embodiment is useful in reducing the number of parts that must be molded while maintaining the same overall structure, design and advantages. According to this embodiment, the top of the mixing nozzle 17a, is formed unitarily with the top of the head 11. FIGS. 14A and 14B illustrate top and bottom views, respectively, of the resulting unit 173. The top of the mixing nozzle 17a is joined with the top of the head 11 by way of frangible tabs 174. The top of the mixing nozzle 17a can be joined to the rear of the top of the head 11 by a flexible tab or hinge 175. FIG. 14C is a side view of the top portion of a dispensing system incorporating the unit 173 in an unactuated position, and illustrates the connection between the top part of the mixing nozzle 17a and the bottom part of the mixing nozzle 17b. FIG. 14D is a side view of the top portion of a dispensing system incorporating the unit 173 upon actuation. In use, initial actuation of the device (as illustrated in FIG. 14D) by depression of the top of the mixing nozzle 17a results in breaking of the frangible tabs 174. Thus, the frangible tabs 174 also serve as a tamper evident device. The flexible tab 175 can remain unbroken to prevent separation of the mixing nozzle 17 from the device.

FIG. 15 illustrates an embodiment of the invention in which the head 176 is constructed as a single piece rather than as top 11 and bottom 10 pieces. In this embodiment, the head 176 includes snap tabs 177 that can connect directly to a pressurized containers 14a, 14b (See FIG. 1.) Similar to the one piece construction of FIG. 14, this one piece version of the head 174 can reduce costs associated with molding, as well as the assembly of the device with the aerosolized components, and also precludes the possibility of inadvertent separation of the upper and lower portions of the head during end use. FIG. 16 illustrates a top view of a device that includes a shipping post 178, or plastic connector between the resilient actuation portion and the main body to both protect from accidental actuation during shipment and provide evidence of prior actuation or tampering. Either the two piece construction of FIGS. 1 and 7-8 and one piece construction of FIG. 15 can incorporate one or more shipping posts 178.

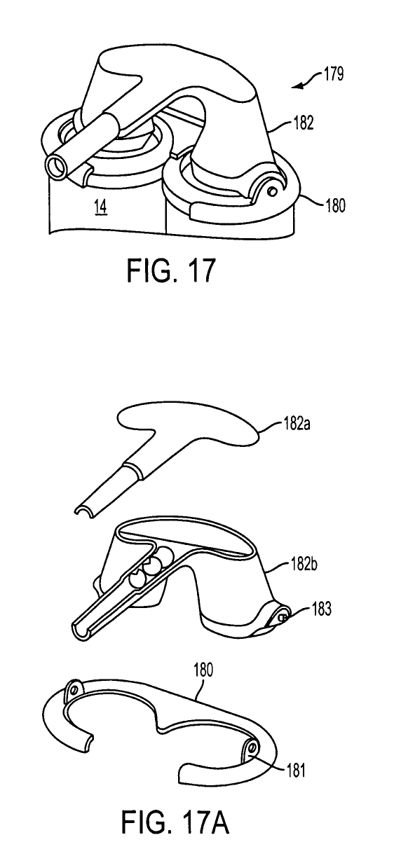

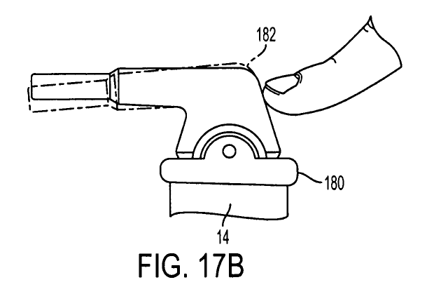

FIG. 17 illustrates another embodiment of a dispensing device 179. As illustrated in the exploded view of FIG. 17A, this embodiment includes a collar piece 180 which attaches atop the pressurized containers 14a, 14b. The collar 180 includes receptacles 181 that provide a pivot point for the mixing nozzle assembly 182. The mixing nozzle 182 can be molded in a top piece 182a and a bottom piece 182b. The internal configuration of the mixing nozzle 182 can be of various configurations, for example those illustrated in FIGS. 3-6 and 10. The top piece 182a and bottom piece 182b can also be molded in a single piece connected by a hinge similar to that illustrated in FIG. 13. The embodiment illustrated in FIG. 17 includes pivot tabs 183. The device 179 is assembled by joining the top piece 182a of the mixing nozzle and bottom piece 182b of the mixing nozzle, for example by ultrasonic welding. The pivot tabs 183 are inserted into the receptacles 181. As illustrated in FIG. 17B, exertion of a force on the mixing nozzle assembly 182 results in a pivoting of the mixing nozzle assembly 182 on the collar 180, resulting in actuation of the tilt-actuated valve stems 16 of the pressurized containers 14. Among other benefits of this embodiment is cost reduction during molding and ultrasonic welding.

The present invention offers several additional advantages over the prior art. The actuation system, e.g., the combination of actuation member 52 and actuation member receiving portion 29, 39, provides a system where the movement of the nozzle such as, for example, mixing nozzle 17, can be facilitated by contact at a single point. The mixing nozzle 17 can move due to a force applied to a single point of contact, for example, in the form of a wedge-shaped recess 29, 39 on the mixing nozzle 17. In use, pressure applied to the resilient actuation portion 50 of the dispensing device head top portion 11, in which the mixing nozzle 17 is encased, is transferred to the mixing nozzle 17 by the actuation member 52 which can be, for example, a triangular projection that fits into the actuation member receiving portion 29, 39. This single point of contact actuation method provides the system with an additional means to equalize or accommodate manufacturing inconsistencies in pressurized containers 14a, 14b such as, for example, uneven valve stem heights, so as to provide dispensing consistency among different sets of pressurized containers.

Another advantage over the prior art is in the flexibility of the design. There are several different nozzle designs, as described above, that can be used interchangeably with the dispensing device of the present invention. For example, a mixing nozzle 17 such as depicted in FIGS. 3-5 can be used to dispense a mixed product in the form of a mixed stream, as depicted in FIG. 11. The mixed stream can be in the form of, for example, a liquid, gel, or paste. With the insertion of a valve insert 19, such as a mechanical breakup valve, in the mixing nozzle, this same system can be used to dispense a mixed and atomized product in the form of a fine spray. As another alternative, the nozzle can be exchanged with another nozzle, for example the side-by-side dispensing nozzle depicted in FIG. 10, to dispense substantially unmixed and discrete side-by-side product streams. The present invention can thus be used for a number of applications that may have previously required several differently designed devices.

The system as described herein is relatively inexpensive to manufacture. In the past different devices were required to provide spray, stream, side-by-side output or output having a different dispensing ratio. Because of the flexibility of the instant invention, a manufacturer can avoid additional start up costs typically involved with supplying a variety of different users with devices having different purposes to fit the individual's needs. With the instant invention, a manufacturer can meet the needs of many different users by supplying the identical dispensing device head top part 11, dispensing device head bottom part 12, and base collar 13, along with a nozzle suitable to the needs of the particular user. Furthermore, the external configuration of the various nozzles is substantially identical; the only differences being in the internal structure. Accordingly, a manufacturer can use the identical set of outside molds in a variety of applications for different customers. These advantages save change-over costs and can provide space savings by using identical equipment to manufacture devices for different types of users.

The flexibility of the system can also provide cost savings to users. If users have different needs for different products, the user only needs to place a different type of nozzle in the device. Furthermore, if a given nozzle becomes clogged or otherwise inoperable, the inoperable nozzle can be removed and replaced; there is no need to replace the entire system. This can be especially true for users that have repeated need for a dispensing device.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A dispensing device comprising:
a nozzle adapted to receive and dispense a plurality of pressurized constituents, the nozzle including
an inlet portion;
an outlet portion spaced from the inlet portion; and
an actuation member receiving portion; and
a head configured to receive the dispensing nozzle therein, the head including
a bottom part mountable atop a plurality of pressurized containers; and
a top part adapted to be received on the bottom part of the head so as to substantially enclose the nozzle, the top part of the head including
a resilient actuation portion formed integrally thereon and adapted to be depressed by a user; and
an actuation member disposed on an internal surface of the resilient actuation portion of the head for contacting the nozzle actuation member receiving portion,
whereby, when the nozzle and the head are mounted atop the plurality of pressurized containers and the resilient actuation portion of the head is depressed by the user, the nozzle shifts relative to the head so as to release the pressurized constituents from each of the plurality of pressurized containers into the nozzle for dispensing therefrom.

2. The dispensing device according to claim 1, wherein the nozzle is adapted to shift at least partially laterally when the resilient actuation portion of the head is depressed by the user so as to activate at least one tilt-actuated valve on the plurality of pressurized containers.

3. The dispensing device according to claim 1, wherein the nozzle is adapted to mix the plurality of pressurized constituents and dispense the constituents as a mixed product.

4. The dispensing device according to claim 3, wherein the nozzle further comprises
a mixing chamber interposed between the inlet portion and the outlet portion, the mixing chamber forming a convoluted flow path between the inlet portion and the outlet portion for mixing the constituents to form the mixed product and comprising
a combining portion in fluid communication with the inlet portion for receiving the constituents; and
a mixing portion in fluid communication with the combining portion, the mixing portion including a plurality of mixing cells in fluid communication with one another along the direction of the flow path.

5. The dispensing device according to claim 4, wherein at least a portion of the mixing portion of the nozzle tapers inwardly toward the outlet portion.

6. The dispensing device according to claim 1, wherein the nozzle is adapted to receive the plurality of pressurized constituents and dispense the constituents as discrete, side-by-side product streams.

7. The dispensing device according to claim 6, the nozzle further comprising
a first flow chamber fluidly connecting a first channel to the outlet portion, at least a portion of the first flow chamber tapering inwardly towards the outlet portion;
a second flow chamber fluidly connecting a second channel to the outlet portion, the second flow chamber being parallel to the first flow chamber and at least a portion of the second flow chamber tapering inwardly towards the outlet portion; and
a wall disposed between the first flow chamber and the second flow chamber, the wall being configured, in use, to keep separate constituents from each of the plurality of pressurized containers,
wherein when the constituents from the plurality of pressurized containers are received in a first inlet and a second inlet, the constituents are conveyed through the first and second channels to the first and second flow chambers, respectively, to the outlet portion so as to be dispensed as discrete side-by-side product streams at the outlet portion.

8. The dispensing device of claim 1, wherein the inlet comprises a channel having a slope end for interconnection with valve stems of the pressurized containers.

9. A nozzle for mixing a plurality of pressurized constituents and dispensing the constituents as a mixed product, the nozzle comprising:
an inlet portion for receiving the plurality of pressurized constituents;
an outlet portion spaced from the inlet portion, the outlet portion for dispensing the mixed product; and
a mixing chamber interposed between the inlet portion and the outlet portion, the mixing chamber forming a convoluted flow path between the inlet portion and the outlet portion for mixing the constituents to form the mixed product and comprising
a combining portion in fluid communication with the inlet portion for receiving the constituents; and
a mixing portion in fluid communication with the combining portion, the mixing portion including a plurality of mixing cells in fluid communication with one another along the direction of the flow path, at least a portion of the mixing portion tapering inwardly toward the outlet portion.

10. The nozzle of claim 9, wherein the inlet portion comprises a plurality of inlets adapted to receive a valve stem on each of a plurality of pressurized containers.

11. The nozzle of claim 9, wherein the mixing portion comprises a plurality of mixing portions including
a first mixing portion in fluid communication with the combining portion, the first mixing portion including a plurality of mixing cells in fluid communication with one another via consecutively unaligned openings along the direction of the flow path; and
a second mixing portion in fluid communication with the first mixing portion, the second mixing portion including a plurality of mixing cells in fluid communication with one another via consecutively unaligned openings along the direction of the flow path,
wherein at least one of the first and second mixing portions of the mixing chamber tapers inwardly toward the outlet portion.

12. The nozzle of claim 9, wherein the nozzle comprises a top part and a bottom part, the top and bottom parts being ultrasonically welded to one another.

13. A dispensing system comprising:
a plurality of pressurized containers each having a valve stem; and
a dispensing device according to claim 1 attached to the plurality of pressurized containers.

14. The dispensing system of claim 13, wherein the valve of each of the plurality of pressurized containers is a tilt-actuated valve.

15. The dispensing device of claim 13, wherein the inlet comprises a channel having a slope end for interconnection with valve stems of the pressurized containers.

16. A nozzle of claim 9, wherein the mixing portion comprises:
a first mixing portion in fluid communication with the combining portion, the first mixing portion including a plurality of mixing cells in fluid communication with one another via consecutively unaligned openings along the direction of the flow path; and
a second mixing portion in fluid communication with the first mixing portion, the second mixing portion including a plurality of mixing cells in fluid communication with one another via consecutively unaligned openings along the direction of the flow path.

17. A multi-constituent side-by-side dispensing nozzle mountable atop a plurality of pressurized containers, the side-by-side dispensing nozzle comprising:
an inlet portion adapted to receive constituents from each of the plurality of pressurized containers, the inlet portion including
a first inlet having a first channel; and
a second inlet having a second channel;
an outlet portion adapted to dispense a product;
a first flow chamber fluidly connecting the first channel to the outlet portion, at least a portion of the first flow chamber tapering inwardly towards the outlet portion;
a second flow chamber fluidly connecting the second channel to the outlet portion, the second flow chamber being parallel to the first flow chamber and at least a portion of the second flow chamber tapering inwardly towards the outlet portion; and
a wall disposed between the first flow chamber and the second flow chamber, the wall being configured, in use, to keep separate constituents from each of the plurality of pressurized containers,
wherein when constituents from the plurality of pressurized containers are received in the first and second inlets, the constituents are conveyed through the first and second channels to the first and second flow chambers, respectively, to the outlet portion so as to be dispensed as discrete side-by-side product streams at the outlet.
